(19) United States
(12) Patent Application Publication
(10) Pub. No.: US 2006/0074979 A1
(43) Pub. Date: Apr. 6, 2006

(54) Static sample data switch

(76) Inventor: Martin Kaiser, Speyer (DE)

Correspondence Address: PERKINS COIE LLP, P.O. BOX 2168, MENLO PARK, CA, 94026, US

(21) Appl. No.: 10/954,512

(22) Filed: Sep. 29, 2004

(51) Int. Cl. G06F 17/00

(52) U.S. Cl. 707/104.1

(57) ABSTRACT

A technique for preventing database access to an active database when using sample data. A database interface facilitates access to a static sample database when a database access request is received that is associated with sample data. The database interface facilitates access to an active database when a database access request is received that is associated with non-sample data.

### BACKGROUND

It is common to test a database, or a system or program associated with the database, by accessing sample data in the database. However, when productive databases are tested or used to test a program, productive data may be retrieved or modified. This may have undesirable consequences. For example, a company that maintains the database may worry about retrieval of productive data for testing purposes out of security or privacy concerns. The company may not want to have test data written into the database, since this can result in fictional database entries or modification of productive data. Moreover, the company may not want sample data read out during normal use of the database. Plus, as a common sense rule, it is simply unwise to risk modification of productive data for the purposes of testing.

### BRIEF DESCRIPTION OF THE DRAWINGS

Embodiments of the invention are illustrated in the figures. However, the embodiments and figures are illustrative rather than limiting; they provide examples of the invention. The invention is limited only by the claims.

FIG. 1 depicts a networked system for use in an embodiment;

FIG. 2 depicts a computer system for use in the system of FIG. 1;

FIG. 3 depicts a portion of the computer system of FIG. 2 and components of the system of FIG. 1;

FIG. 4 depicts a flowchart of an exemplary method for providing a database interface according to an embodiment;

FIG. 5 depicts a system in which programs access, through a database interface, a static sample database or an active database;

FIG. 6 depicts a flowchart of an exemplary method for static data sampling;

FIG. 7 depicts an alternative system in which programs access, through a database interface, a static sample database or an active database;

FIG. 8 depicts a flowchart of an alternative method for static data sampling;

FIG. 9 depicts exemplary database interfaces according to an embodiment;

FIG. 10 depicts an example of delegation of a database interface according to an embodiment.

### DETAILED DESCRIPTION OF THE INVENTION

A technique for facilitating access to static sample data involves receiving a request for a database interface, determining a static sample data interface should be included, and instantiating an instance of a database interface including access to static sample data. A system developed according to this technique may include a static sample switch that may be set to enabled or disabled, a static sample database that includes static sample data, and a database interface configured to facilitate access to the static sample database when the static sample switch is enabled and to an active database when the static sample switch is disabled. In operation, the database interface facilitates receiving a database access request at the database interface, determining whether the database access request is associated with sample data, and accessing a static sample database if the database access request is associated with sample data.

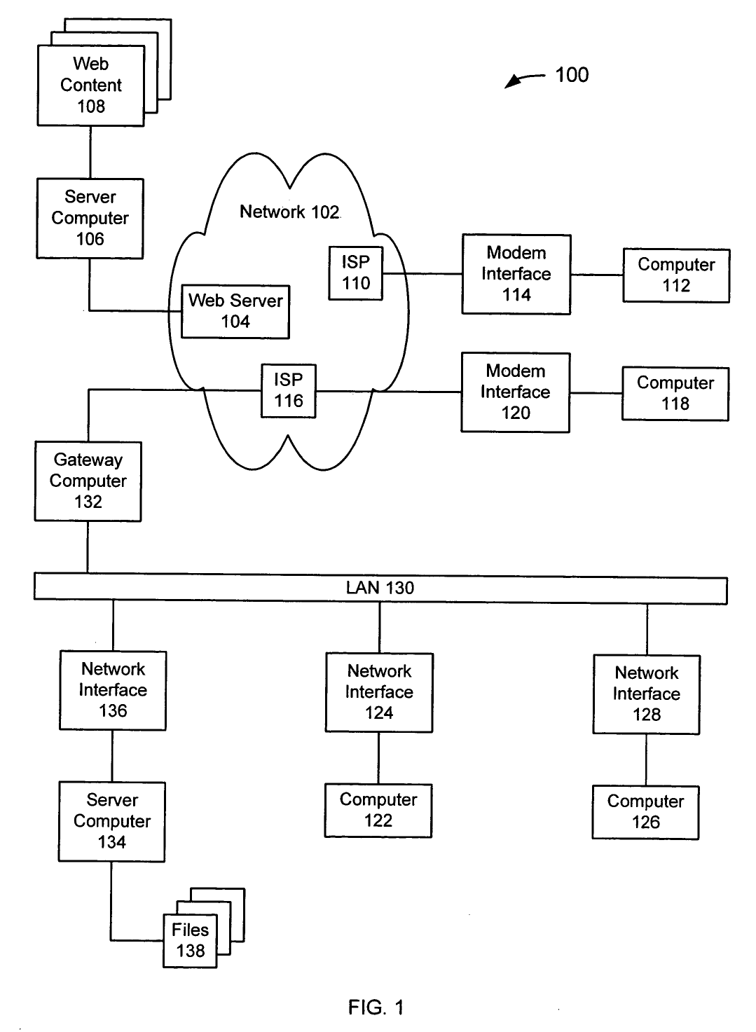

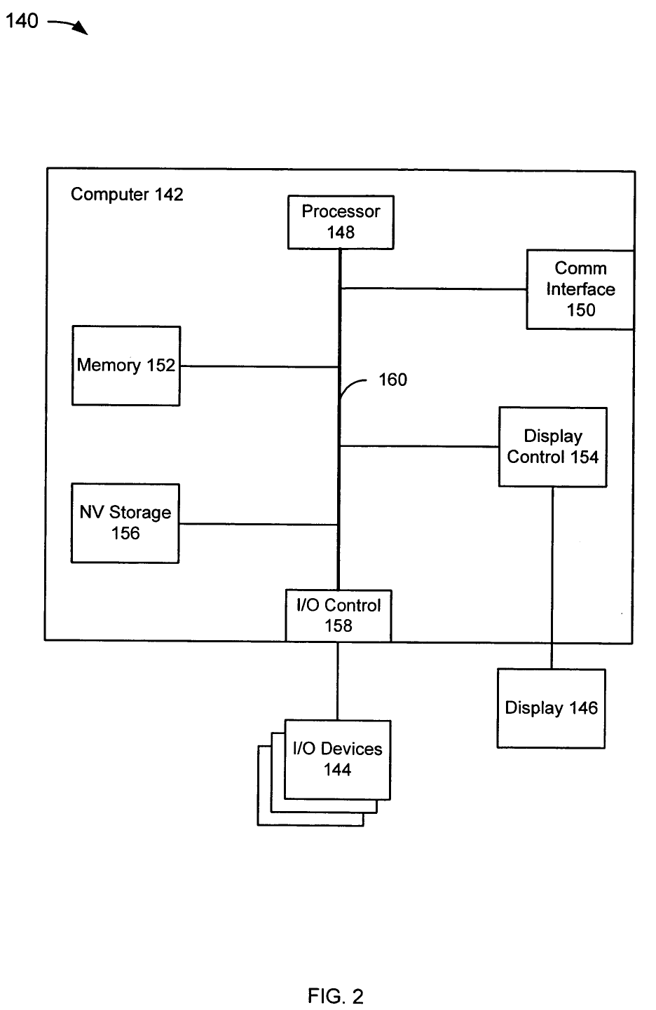

The following description of FIGS. 1 and 2 is intended to provide an overview of computer hardware and other operating components suitable for performing the methods of the invention described herein, but is not intended to limit the applicable environments. Similarly, the computer hardware and other operating components may be suitable as part of the apparatuses of the invention described herein. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 1 depicts a networked system 100 that includes several computer systems coupled together through a network 102, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web). The physical connections of the Internet and the protocols and communication procedures of the Internet are well known to those of skill in the art.

The web server 104 is typically at least one computer system which operates as a server computer system and is configured to operate with the protocols of the world wide web and is coupled to the Internet. The web server system 104 can be a conventional server computer system. Optionally, the web server 104 can be part of an ISP which provides access to the Internet for client systems. The web server 104 is shown coupled to the server computer system 106 which itself is coupled to web content 108, which can be considered a form of a media database. While two computer systems 104 and 106 are shown in FIG. 1, the web server system 104 and the server computer system 106 can be one computer system having different software components providing the web server functionality and the server functionality provided by the server computer system 106, which will be described further below.

Access to the network 102 is typically provided by Internet service providers (ISPs), such as the ISPs 110 and 116. Users on client systems, such as client computer systems 112, 118, 122, and 126 obtain access to the Internet through the ISPs 110 and 116. Access to the Internet allows users of the client computer systems to exchange information, receive and send e-mails, and view documents, such as documents which have been prepared in the HTML format. These documents are often provided by web servers, such as web server 104, which are referred to as being “on” the Internet. Often these web servers are provided by the ISPs, such as ISP 110, although a computer system can be set up and connected to the Internet without that system also being an ISP.

Client computer systems 112, 118, 122, and 126 can each, with the appropriate web browsing software, view HTML pages provided by the web server 104. The ISP 110 provides Internet connectivity to the client computer system 112 through the modem interface 114, which can be considered part of the client computer system 112. The client computer system can be a personal computer system, a network computer, a web TV system, or other computer system. While FIG. 1 shows the modem interface 114 generically as a “modem,” the interface can be an analog modem, isdn modem, cable modem, satellite transmission interface (e.g. “direct PC”), or other interface for coupling a computer system to other computer systems.

Similar to the ISP 114, the ISP 116 provides Internet connectivity for client systems 118, 122, and 126, although as shown in FIG. 1, the connections are not the same for these three computer systems. Client computer system 118 is coupled through a modem interface 120 while client computer systems 122 and 126 are part of a LAN 130.

Client computer systems 122 and 126 are coupled to the LAN 130 through network interfaces 124 and 128, which can be ethernet network or other network interfaces. The LAN 130 is also coupled to a gateway computer system 132 which can provide firewall and other Internet-related services for the local area network. This gateway computer system 132 is coupled to the ISP 116 to provide Internet connectivity to the client computer systems 122 and 126. The gateway computer system 132 can be a conventional server computer system.

Alternatively, a server computer system 134 can be directly coupled to the LAN 130 through a network interface 136 to provide files 138 and other services to the clients 122 and 126, without the need to connect to the Internet through the gateway system 132.

FIG. 2 depicts a computer system 140 for use in the system 100 (FIG. 1). The computer system 140 may be a conventional computer system that can be used as a client computer system or a server computer system or as a web server system. Such a computer system can be used to perform many of the functions of an Internet service provider, such as ISP 110 (FIG. 1). The computer system 140 includes a computer 142, I/O devices 144, and a display device 146. The computer 142 includes a processor 148, a communications interface 150, memory 152, display controller 154, non-volatile storage 156, and I/O controller 158. The computer system 140 may be couple to or include the I/O devices 144 and display device 146.

The computer 142 interfaces to external systems through the communications interface 150, which may include a modem or network interface. It will be appreciated that the communications interface 150 can be considered to be part of the computer system 140 or a part of the computer 142. The communications interface can be an analog modem, isdn modem, cable modem, token ring interface, satellite transmission interface (e.g. “direct PC”), or other interfaces for coupling a computer system to other computer systems.

The processor 148 may be, for example, a conventional microprocessor such as an Intel Pentium microprocessor or Motorola power PC microprocessor. The memory 152 is coupled to the processor 148 by a bus 160. The memory 152 can be dynamic random access memory (dram) and can also include static ram (sram). The bus 160 couples the processor 148 to the memory 152, also to the non-volatile storage 156, to the display controller 154, and to the I/O controller 158.

The I/O devices 144 can include a keyboard, disk drives, printers, a scanner, and other input and output devices, including a mouse or other pointing device. The display controller 154 may control in the conventional manner a display on the display device 146, which can be, for example, a cathode ray tube (CRT) or liquid crystal display (LCD). The display controller 154 and the I/O controller 158 can be implemented with conventional well known technology.

The non-volatile storage 156 is often a magnetic hard disk, an optical disk, or another form of storage for large amounts of data. Some of this data is often written, by a direct memory access process, into memory 152 during execution of software in the computer 142. One of skill in the art will immediately recognize that the terms “machine-readable medium” or “computer-readable medium” includes any type of storage device that is accessible by the processor 148 and also encompasses a carrier wave that encodes a data signal.

The computer system 140 is one example of many possible computer systems which have different architectures. For example, personal computers based on an Intel microprocessor often have multiple buses, one of which can be an I/O bus for the peripherals and one that directly connects the processor 148 and the memory 152 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 152 for execution by the processor 148. A Web TV system, which is known in the art, is also considered to be a computer system according to the present invention, but it may lack some of the features shown in FIG. 2, such as certain input or output devices. A typical computer system will usually include at least a processor, memory, and a bus coupling the memory to the processor.

In addition, the computer system 140 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 156 and causes the processor 148 to execute the various acts required by the operating system to input and output data and to store data in memory, including storing files on the non-volatile storage 156.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the present invention is not described with reference to any particular programming language, and various embodiments may thus be implemented using a variety of programming languages.

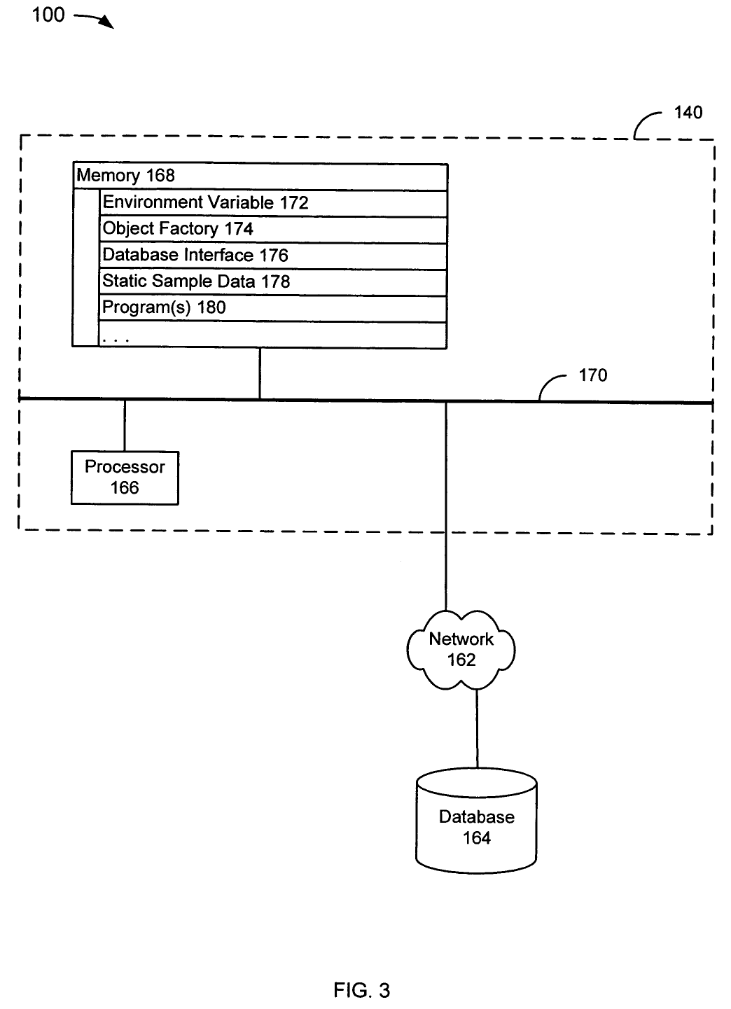

FIG. 3 depicts a portion of the computer system 140 (FIG. 2) and components of the system 100 (FIG. 1). FIG. 3 depicts the computer system 140, a network 162, and a database 164. The network 162 could be a global information network, such as the Internet, a local or wide area network (LAN or WAN), or some other intranet or network. For example, the network 102 (FIG. 1) could include the network 162. Alternatively, the LAN 130 (FIG. 1) could include the network 162.

The database 164 may be stored in non-volatile storage coupled to and accessible through the network 162. The database could be part of a computer system, such as the computer system 140 (FIG. 2). The database could be served as Web content, such as by the server computer 106 (FIG. 1). The database could be part of a server computer on a LAN or WAN, such as the server computer 134 (FIG. 1). The database 164 is typically accessible through the network 162 by other remote computers. The database 164 may be referred to as an active database because it is intended to include productive, or non-sample, data. Though sample data could be written to the database 164 if desired, an advantage provided by some embodiments, is that sample data need not be included in the database 164. This ensures that productive data is not requested or modified during testing procedures, fictional entries are not made to the database 164, and sample and non-sample data is otherwise segregated.

The computer system 140 includes a processor 166, a memory 168, and a bus 170 that couples the processor 166 to the memory 168. The memory 168 may include both volatile memory, such as DRAM or SRAM, and non-volatile memory, such as magnetic or optical storage. The processor 166 executes code in the memory 168. The memory 168 includes an environment variable 172, an object factory 174, a database interface 176, static sample data 178, and programs 180. The environment variable 172 may be a user-dependent environment variable. Alternatively, the environment variable may be an object stored in volatile or non-volatile memory that acts like an environment variable. In another alternative, the environment variable 172 may be stored in a server configuration, in a database table, or some other medium. The environment variable 172 may be referred to as a sample data switch, which may be enabled or disabled. Alternatively, a sample data switch (not shown) may be enabled or disabled according to a value of the environment variable 172. The sample data switch may or may not be included in the database interface 176.

The object factory 174 instantiates the database interface 176. The database interface 176 may be an object or some other software or firmware data structure. The database interface 176 may include static sample data 178. The static sample data 178 may be referred to collectively as a static sample database. In an embodiment, the static sample data 178 is included in the database interface 176 if the environment variable 172 is set to indicate sample data may be used. Advantageously, the environment variable 172 need not be queried again after the database interface 176 has been instantiated, improving speed.

In another embodiment, the database interface 176 includes the static sample database regardless of the setting of the environment variable 172 and the environment variable 172 is checked each time a database access request is received at the database interface 176 to determine whether to facilitate access to the static sample database. In any case, the static sample data should be available relatively quickly. For example, the static sample database may be stored locally or downloaded and stored locally. Since the sample data is static, it cannot be damaged. Thus, testing may be conducted in the same manner for multiple systems. Access to the static data is fast because, for example, there is no active database query. Thus, sample data can be readily provided without consuming any bandwidth associated with the active database.

It should be noted that the static sample database need not be a traditional database. The static sample database could be a software program, routine, module, function, or procedure that includes data by way of source code. For example, for sample data indicating Employee 4711 was born Apr. 1, 1990, the static sample database could be implemented as “IF switch=on AND Employee=4711; return 1990 Apr. 1; ELSE query active database.” In this way, the static sample database can emulate a database for sample data or query a productive database when the query is for non-sample data.

The programs 180 access the database 164 through the database interface 176. In an alternative embodiment, a database interface may be instantiated for each of the programs 180, for a subset of the programs 180, or for all of the programs 180. The subset of the programs 180 that utilize the same database interface 176 may be, for example, those programs that are used by a particular user. Requests for sample data may include an identifiable flag or other value that identifies the request as associated with sample data. The flag may be set by the program generating the request, by an environment variable, by the user, or by some other mechanism for identifying requests as associated with sample data. Alternatively, the requests may not be distinguished. For example, if the environment variable 172 is enabled and the database interface 176 includes the static sample database, then database access requests through the database interface 176 may be automatically associated with sample data.

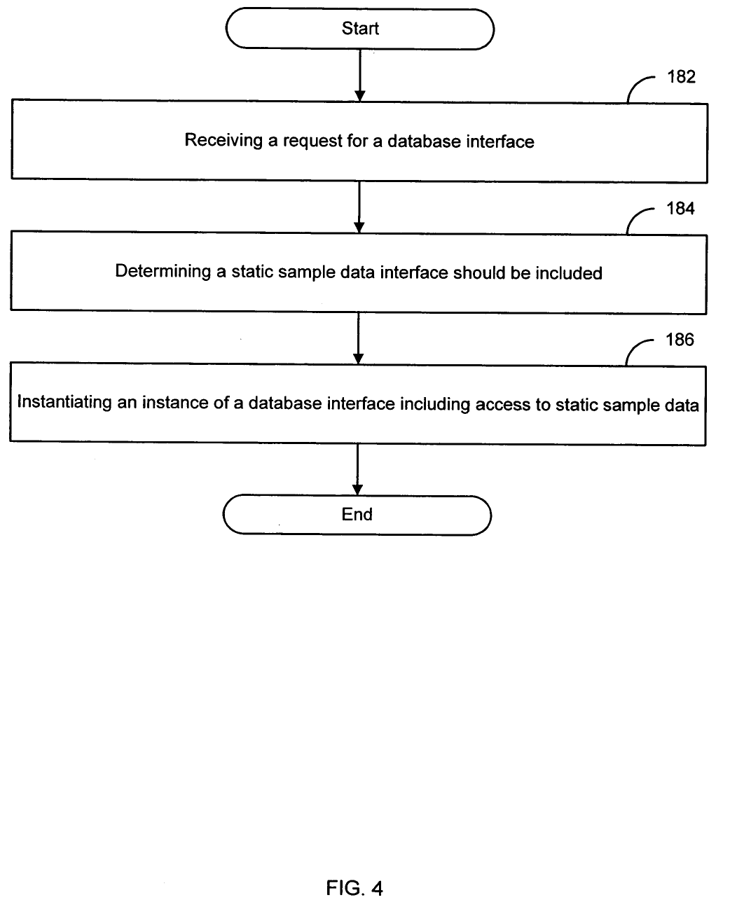

Various methods may be used to provide a database interface such as the database interface 176, for example. FIG. 4 depicts a flowchart of an exemplary method for providing a database interface according to an embodiment. The method starts at module 182 when a request for a database interface is received. The request for a database interface may be provided by a remote or local computer program. Alternatively, the request for a database interface may be generated in response to receiving a request for database access from a remote or local computer program.

In this embodiment, the flowchart continues at module 184 with a determination of whether a static sample data interface should be included. The determination may be made by checking an environment variable. The environment variable may be set by an administrator. The administrator may enable a static sample switch by setting the environment variable accordingly. When the static sample data switch is enabled, a static sample data interface should be included. For the purposes of example, it is assumed that the static sample data switch is enabled. Accordingly, at module 184 the determination is made that the static sample data interface should be included.

In this embodiment, the method ends at module 186 with instantiation of an instance of a database interface including access to static sample data. The database interface may include the static sample data, the static sample data may be locally available, or the static sample data may be remotely available. This method and other methods are depicted as serially arranged modules. However, modules of the methods may be reordered, or arranged for parallel execution as appropriate.

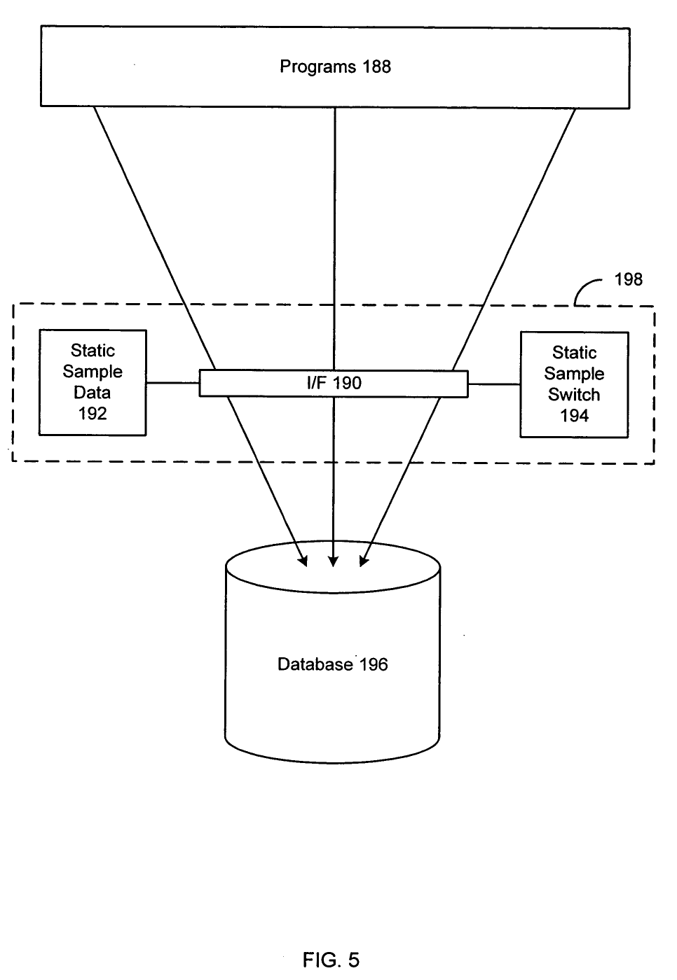

Various systems facilitate the provision of a database interface according to methods such as described with reference to FIG. 4, for example. FIG. 5 depicts a system 100 in which programs 188 access, through a database interface 190, a static sample database 192 or a database 196. In the example of FIG. 5, each program accesses the database 196 through the same interface 190. In an alternative embodiment, each program accesses the database 196 through distinct interfaces. Each of the programs 188 may be stored on the same computer (i.e., locally with respect to one another) or the programs may be associated in some other way. For example, the programs may be executed by the same user or the programs may be executed on computers coupled to a LAN, wherein the LAN has an associated interface that is used by each program.

A static sample switch 194 is used to determine whether the database access requests are directed to the static sample database 192. If the static sample switch 194 is disabled, database access requests are used to access the database 196 normally. However, if the static sample switch 194 is enabled, database access requests are used to access the static sample database 192 instead. In an alternative embodiment, the database access requests are checked to determine whether the request is associated with sample data. In this alternative embodiment, if the request is associated with sample data and the static sample switch 194 is enabled but the database access requests are associated with non-sample data, the interface 190 may facilitate access to the database 196 as normal. In an embodiment, the static sample switch 194 is checked only once when the interface 190 is instantiated. In this embodiment, the static sample switch 194 need not be checked each time the interface 190 receives a database access request.

The components depicted in FIG. 5 may have a variety of different physical layouts. For example, as represented by the dashed box 198, the interface 190, static sample data 192, and static sample switch 194 may be local to one another (e.g., located on the same computer system), while the programs 188 and database 196 are remote. Alternatively, some or all of the programs 188 may be executed locally. In another alternative embodiment, the static sample data 192 or the static sample switch 194 are remote.

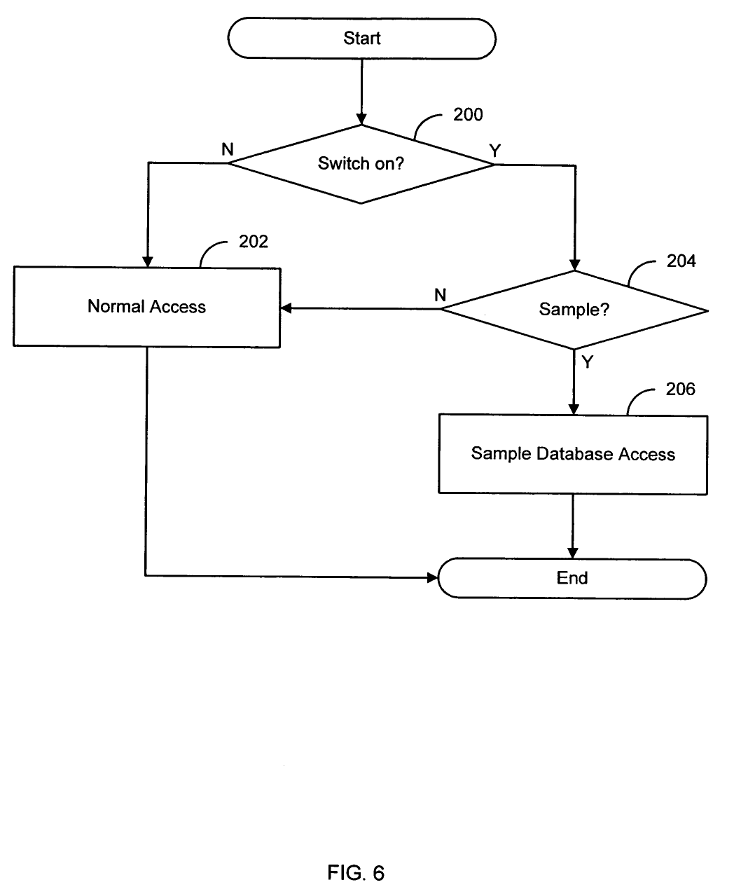

Various methods may be used to provide a database interface that facilitates static data sampling such as the database interface 190, for example. FIG. 6 depicts a flowchart of an exemplary method for static data sampling. The flowchart is intended to illustrate how a database interface disposes a database access request received at the database interface. The flowchart begins at module 200 with determining whether a switch is on. The switch may be a static sampling data switch that is enabled when testing of a database or programs that access the database is desired. Alternatively, the switch may be enabled all the time, which may be appropriate for computing devices that are used for test or demonstration purposes. It should be noted that module 200 need not be associated with a step or action. For example, the switch may be checked prior to instantiating a database interface, in which case the switch may or may not be re-checked each time a database access request is received at the database interface.

If the switch is off (200-N), then at module 202 a database is accessed normally and the flowchart ends. If the switch is on (200-Y), then at module 204 it is determined whether the data is sample data. In an alternative embodiment, sample data is assumed. For example, if the switch is on at module 200, then, in this alternative, it is always determined at module 204 that sample data is used. It may be desirable to indicate whether data is sample data or not on a case-by-case basis. Accordingly, a database access request may include, for example, a flag that identifies a particular request as associated with sample data or as associated with productive, or non-sample, data.

If the data is not sample data (204-N), then at module 202 the database is accessed normally and the flowchart ends. If the data is sample data (204-Y), then at module 206 a sample database is accessed and the flowchart ends. The database interface facilitates access to a static sample database if the database access request is associated with sample data. This may include forwarding the request to the static sample database or accessing the static sample database directly.

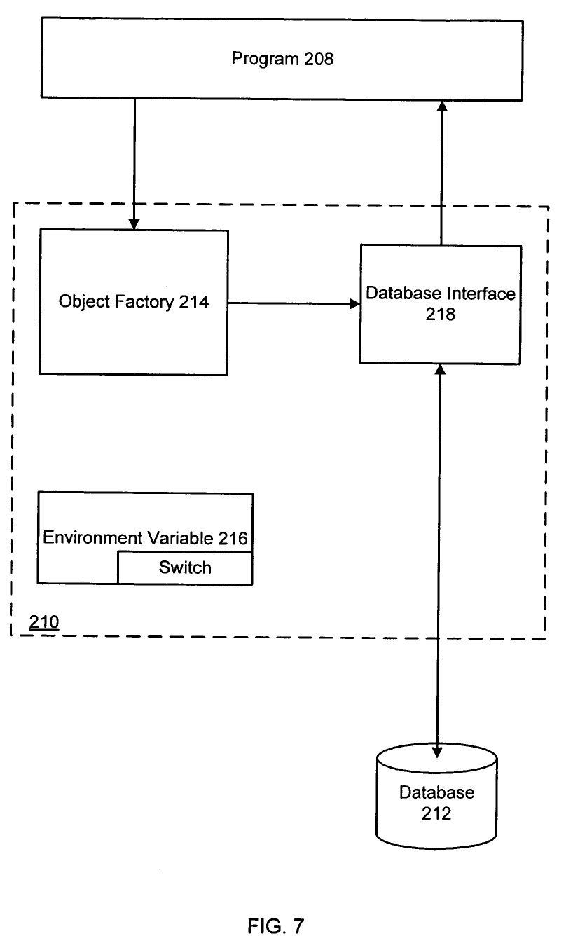

Another system that facilitates the provision of a database interface according to methods such as described with reference to FIG. 4, for example, is depicted in FIG. 7. FIG. 7 includes a program 208, an intermediary 210, and a database 212. The intermediary includes an object factory 214, an environment variable or switch 216, and a database interface 218. In operation, the program 208 sends a database access request to the intermediary 210. The object factory 214, in response to the database access request and in accordance with the switch 216, spawns the database interface 218. If the switch 216 is enabled, then the database interface 218 includes a static sample database. In this case, the database interface 218 intercepts database access requests from the program 208 and permits access to a static sample database (not shown) instead of the database 212. If the switch 216 is disabled, then the database interface 218 does not include a static sample database and permits access to the database 212. Using the system depicted in the example of FIG. 7, a system that includes the program 208 can test a system, demonstrate a system, or perform other functions without accessing productive data in the database 212.

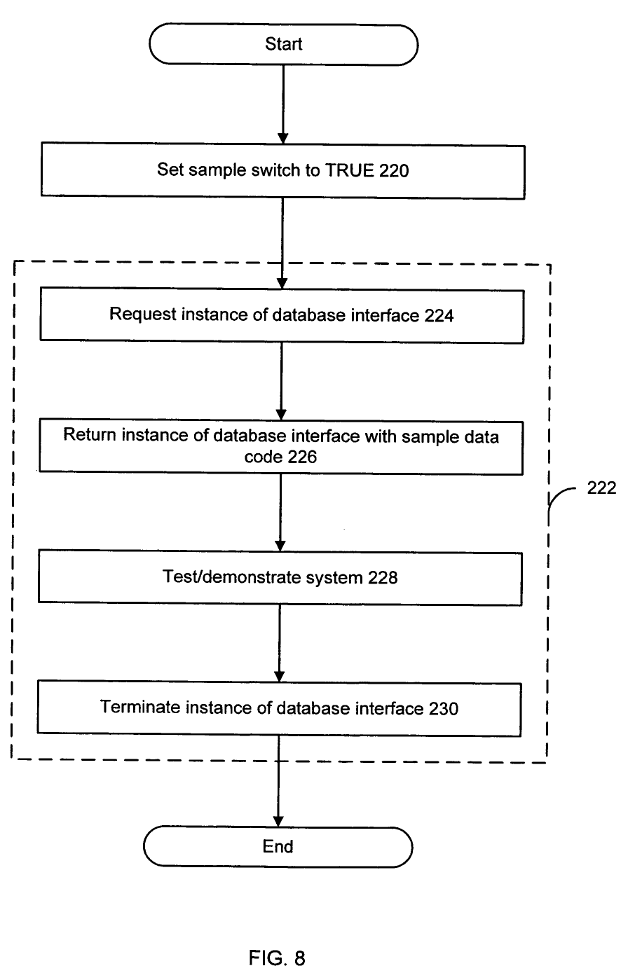

Various methods may be used to provide a database interface that facilitates static data sampling such as the database interface 218, for example. FIG. 8 depicts a flowchart of an exemplary method for static data sampling.

In this embodiment, the method starts at module 220 with setting a sample switch to TRUE. The determination as to whether to set the sample switch to TRUE may be made by a human or robotic operator. For example, an operator may decide to demo a system for a customer, in which case the operator determines that the sample switch should be set to TRUE. The module 220 may or may not encompass actions that are taken during a configuration stage.

In this embodiment, the method continues into a runtime stage. For illustrative purposes only, modules associated with the runtime stage are encompassed by the dashed box 222 in FIG. 8. At module 224 an instance of a database interface is requested. The request may be received from a local or remote program during runtime. At module 226 an instance of a database interface with sample data code is returned. Then, at module 228, a system may be tested using the sample data. The method ends at module 230 when the instance of the database interface is terminated.

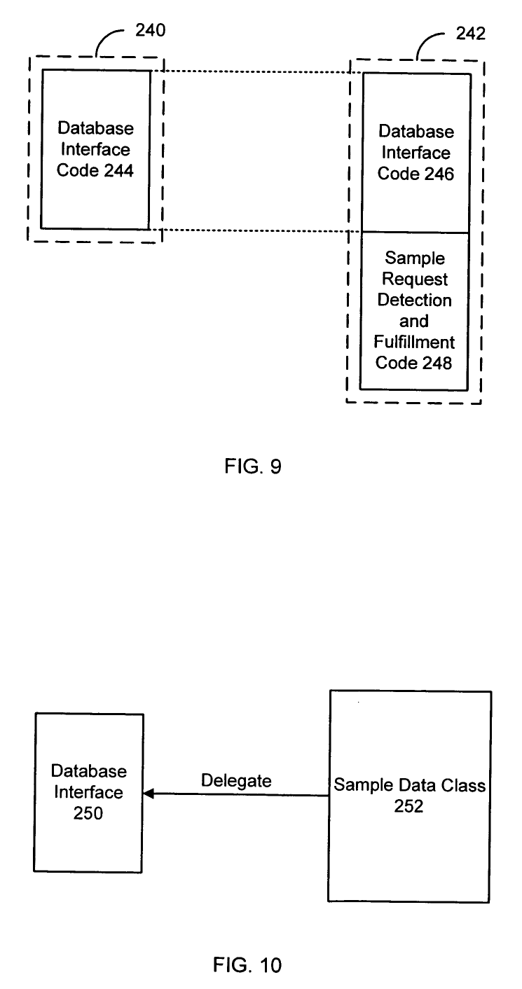

The database interface that is instantiated when the sample switch is TRUE may be similar to the database interface that is instantiated when the sample switch is FALSE. For example, as depicted in FIG. 9, a database interface 240 instantiated when the sample switch is FALSE may be different from a database interface 242 instantiated when the sample switch is TRUE. In the example of FIG. 9, the database interface 240 includes database interface code 244, while the database interface 242 includes both database interface code 246 and sample request detection and fulfillment code 248. The sample request detection and fulfillment code 248 may or may not include a static sample database. For example, the static sample database may be included within the sample request detection and fulfillment code 248, or may be locally or remotely available.

The database interface 218 may be delegated in accordance with normal object-oriented inheritance. FIG. 10 illustrates the delegation of a database interface 250 from a sample data class 252. The delegation may be in the form of a method or function call. The database interface 250 may be a wrapper class.

While this invention has been described in terms of certain exemplary embodiments, it will be appreciated by those skilled in the art that certain modifications, permutations and equivalents thereof are within the inventive scope of the present invention. It is therefore intended that the following appended claims include all such modifications, permutations and equivalents as fall within the true spirit and scope of the present invention; the invention is limited only by the claims.

What is claimed is:

1. A system, comprising:
a static sample switch that may be set to enabled or disabled;
a static sample database, wherein the static sample database includes static sample data;
a database interface, coupled to the static sample switch and the static sample database, configured to:
facilitate access to the static sample database when the static sample switch is enabled, and
facilitate access to an active database when the static sample switch is disabled.

2. The system of claim 1, further comprising an environment variable, wherein a value of the environment variable corresponds to the setting of the static sample switch.

3. The system of claim 1, further comprising an object factory that produces the database interface according to the static sample switch setting.

4. The system of claim 3, wherein the object factory incorporates the static sample database into the database interface if the static sample switch is enabled.

5. The system of claim 3, wherein said database interface is further configured to receive a database access request from a program and forward the database access request to the active database if the sample static switch is disabled when the object factory produces the database interface.

6. The system of claim 1, wherein said database interface is further configured to receive a database access request from a program and forward the database access request to the active database when the sample static switch is disabled.

7. The system of claim 1, wherein said database interface is further configured to receive a database access request from a program and forward the database access request to the static sample database when the static sample switch is enabled and the database access request is associated with sample data.

8. The system of claim 1, wherein said database interface is further configured to receive a database access request from a program, establish that the static sample switch is enabled, and access the static sample database in accordance with the database access request.

9. A method, comprising:
receiving a request for a database interface;
determining a static sample data interface should be included; and
instantiating an instance of a database interface including access to static sample data.

10. The method of claim 9, further comprising receiving a request for database access, wherein the request for database access is associated with the request for a database interface.

11. The method of claim 9, further comprising checking an environment variable to determine whether the static sample data interface should be included.

12. The method of claim 9, further comprising including a switch in the database interface that is set according to whether a request for database access through the database interface is associated with sample data.

13. The method of claim 12, further comprising facilitating access to the static sample data if the request for database access through the database interface is associated with sample data.

14. The method of claim 12, further comprising facilitating access to productive data if the request for database access through the database interface is associated with non-sample data.

15. A method, comprising:
receiving a database access request at a database interface;
determining whether the database access request is associated with sample data; and
facilitating access to a static sample database if the database access request is associated with sample data.

16. The method of claim 15, further comprising determining whether a static sample data switch is enabled, wherein the access to a static sample database is facilitated if the database access request is associated with sample data and the static sample data switch is enabled.

17. The method of claim 16, further comprising checking an environment variable to determine whether the static sample switch is enabled.

18. The method of claim 15, further comprising intercepting a database access request to an active database and rerouting the database access request to the static sample database if the database access request is associated with sample data.

19. The method of claim 15, further comprising facilitating access to an active database if the database access request is associated with non-sample data.

20. The method of claim 19, further comprising determining whether a static sample data switch is disabled.
